(19) United States
(12) Patent Application Publication
(10) Pub. No.: US 2026/0009908 A1
(43) Pub. Date: Jan. 8, 2026

(54) DEVICE AND METHOD FOR DETECTING DIFFERENCE IN SIGNALS GENERATED FROM MULTIPLE CHANNELS IN SINGLE FREQUENCY RECEIVER

(71) Applicants: YOUNG MIN YOON, SEJONG (KR); SO YOUNG HAN, SEJONG (KR)

(72) Inventors: YOUNG MIN YOON, SEJONG (KR); SO YOUNG HAN, SEJONG (KR)

(21) Appl. No.: 19/128,596

(22) PCT Filed: Nov. 14, 2023
(86) PCT No.: PCT/KR2023/018231

§ 371 Date: May 9, 2025

(30) Foreign Application Priority Data
Nov. 15, 2022 (KR) 10-2022-0153063

(51) Int. Cl. G01S 19/20; G01S 19/22; G01S 19/23

(52) U.S. Cl. CPC G01S 19/20; G01S 19/22; G01S 19/23

(57) ABSTRACT

A device for detecting a difference between signals in multiple channels, according to the present invention, may comprise: a plurality of sensors which are arranged geometrically on the same plane, and which detect a plurality of signals transmitted through a plurality of channels respectively corresponding to a plurality of sources, so as to output raw time series measurements for each channel, the plurality of sensors simultaneously measuring signals transmitted through any one of the plurality of channels; a signal processing unit, which process the raw time series measurements for each channel that is output from each of the plurality of sensors, so as to generate processed time series measurements; an data processing unit which calculates a crossing rate for each channel by using the processed time series measurements corresponding to two sensors selected from the plurality of sensors, and which connects the crossing rate between the plurality of sensors; and a change detection unit for detecting a channel in which a signal difference occurs in the crossing rate for each channel.

### CROSS-REFERENCE TO RELATED APPLICATION

The present application is a national phase entry under 35 U.S.C. § 371 of International Application NO. PCT/KR 2023/018231 filed Nov. 14, 2023 which claims priority to Korean Patent Application No. 10-2022-0153063 filed on Nov. 15, 2022 in the Republic of Korea, the disclosure of which are incorporated herein by reference.

### TECHNICAL FIELD

The present invention relates to a technology for detecting the difference in signals between channels by calculating the channel-by-channel cross-ratio in a multi-channel receiver using a single frequency.

### BACKGROUND

When two or more sensors receive signals from the same source, processing at the receiver must be performed adaptively, depending on the path the signal takes when it arrives at each sensor. Using the Global Navigation Satellite System (“GNSS”) as an example, if a fixed loss occurs while tracking a satellite signal, the receiver must recount the integers of the size of the carrier wavelength. The phenomenon in which the receiver must recount the integers is called cycle slip (“CS”). The main causes of cycle slip are signal interference from obstacles, low signal strength, or signal processing failure in the receiver. If the receiver cannot detect cycle slip, an error in position determination may occur.

CS, which is the difference in signals between channels due to various internal/external factors, occurs not only in communication systems such as satellite navigation system, RADAR (radio detection and ranging), and LiDAR (light detection and ranging), but also in image sensors. CS is a phenomenon in which abnormalities in carrier measurements occur in satellite navigation systems. Therefore, it is used here to refer to the phenomenon that signals measured from one common source (RADAR, LiDAR, image sensor, etc.) are different from each other (signal anomalies, differences between signals, etc.). In other words, as a method of describing the differences between signals measured from a single source, CS which occurs individually in GNSS receivers can be cited as a representative example.”

Previous studies on CS have been conducted in various fields. Previous studies have suggested methods of combining different equipment or using expensive receivers to detect and mitigate CS, but these methods have limitations in harsh conditions such as urban environments.

Satellite navigation systems such as GPS (Global Positioning System) and GNSS are widely used in urban areas. To determine an accurate position in an urban environment where satellite navigation signals are not easily received without special additional equipment and support, it is necessary to use a carrier wave to calculate an accurate position, to use a low-cost receiver that has only a single frequency available without any other auxiliary means, and to detect CS that occur simultaneously on multiple channels in urban areas.

The carrier wave can be used to estimate the exact position, but there is a problem of determining the unknown number. Therefore, in order to detect CS using the carrier wave, the position must be known or an accurate position estimate must be made in advance, which is not easy to apply in practice. Since the geometry-free combination of dual frequencies uses an expensive receiver, it is effective in eliminating errors caused by the ionosphere, but it is difficult to detect CS because the position estimate changes when the receiver moves. The time difference method can eliminate unknown numbers, but CS detection performance is poor in dynamic situations. The position can be determined using code measurements, but small CS cannot be detected due to large noise. The method combining Doppler can estimate the position through Doppler, but the performance is poor due to complex movement.

A consistency check technique that uses redundant measurements is the RAIM (Receiver Autonomous Integrity Monitoring) technique used in aviation. It performs a statistical consistency check using redundant measurements, but it is difficult to detect CS occurring in multiple channels. The RANCO (Range Consensus) technique proposed to solve this problem is difficult to process in real time at the receiver end because it computes all combinations to find a normal channel.

The studies proposed so far require channel-specific detection for multi-channel detection, and there are RAIM and RANCO as consistency check techniques, but there are limitations in practical application. In addition, when using a single frequency carrier, all techniques require estimation or can only detect large CS using code measurements.

### DETAILED DESCRIPTION

### Technical Objectives

The present invention is intended to provide a technique for determining the baseline of a measurement using a cross ratio, which is a geometric relationship between a source that generates or reflects a signal and a sensor that measures the signal, and for detecting a sharp change in the signal. The source and the sensor can be connected with various frequency band signals such as light, radio waves, and sound. Sensors such as image sensors, RADARs, LiDARs, and GPS receivers can detect and estimate position, attitude, etc. by signals. Since radio waves are transmitted at the speed of light, distances and angles can be calculated from the difference in the measured times.

### Technical Solution

According to one aspect of the present invention, there is provides a device for detecting a difference in cross ratios between channels, including a plurality of sensors, being arranged on the same plane, and configured for detecting signals transmitted through channels corresponding to one source and outputting raw time series measurements, a signal processing unit, being configured for processing the raw time series measurements from each of the plurality of sensors to generate processed time series measurements, a data processing unit, being configured for calculating cross ratios using the processed time series measurements corresponding to the plurality of sensors and connecting data between the plurality of sensors, and a change detection unit, being configured for detecting a channel in which a difference in the cross ratio occurs.

In one embodiment, the signal processing unit is configured for sequentially performs one or a combination of source difference, sensor difference, and time difference on the raw time series measurements using a geometric relationship between the source and the plurality of sensors to generate the processed time series measurement, and the processed time series measurements are one of a single-differenced time series measurement, a double-differenced time series measurement, and a triple-differenced time series measurement.

In one embodiment, the data processing unit is configured for estimating the processed time series measurements using a moving average filter.

In one embodiment, each of the plurality of sensors is configured for detecting a plurality of signals transmitted through a plurality of channels, each corresponding to a plurality of sources, and generating the raw time series measurements for each channel, the signal processing unit is configured for processing the raw time series measurements for each channel from each of the plurality of sensors to generate the processed time series measurements, and the data processing unit is configured for generating cross ratios with the processed time series measurements for each channel.

In one embodiment, the change detection unit is configured to applying a threshold set according to a magnitude of the difference in cross ratios to be detected.

In one embodiment, the differences between the cross ratios are identical in spatial and temporal domains.

According to another aspect of the present invention, there is provides anon-transitory computer program stored in a computer-readable medium that causes a computer to perform a method for detecting a difference in cross ratios between channels, the computer program causing a computer to perform the following steps, the steps including causing a plurality of sensors to detect signals transmitted through channels corresponding to one source, respectively, and outputting raw time series measurements, processing the raw time series measurements from each of the plurality of sensors to generate processed time series measurements, calculating cross ratios using the processed time series measurements corresponding to the plurality of sensors and an estimate through estimation, and detecting a channel or sensor in which a difference in the cross ratio occurs based on the calculated cross ratios.

In one embodiment, the processed time series measurements are generated by sequentially performing one or a combination of source difference, sensor difference, and time difference on the raw time series measurements using a geometric relationship between the source and the plurality of sensors to generate the processed time series measurement, and the processed time series measurements are one of a single-differenced time series measurement, a double-differenced time series measurement, and a triple-differenced time series measurement.

In one embodiment, the processing the raw time series measurements from each of the plurality of sensors to generate processed time series measurements further includes processing the processed time series measurements into the estimate.

In one embodiment, the calculating cross ratios using the processed time series measurements corresponding to the plurality of sensors and an estimate through estimation includes calculating a first cross ratio with the raw or processed time series measurements, calculating a second cross ratio by an estimation using the raw or processed time series measurements, calculating a third cross ratio by combining the raw or processed time series measurements and the estimation, complementarily storing, for comparison, the first to third cross ratios, and complementarily connecting a cross ratio calculated from homogeneous sensors among the plurality of sensors and a cross ratio calculated between heterogeneous sensors among the plurality of sensors.

In one embodiment, the detecting a channel or sensor in which a difference in the cross ratio occurs based on the calculated cross ratios includes setting a threshold according to a magnitude of difference of cross ratio between homogeneous sensors to be detected among the plurality of sensors, detecting the difference of cross ratio by applying the threshold to the cross ratio, and detecting the difference of cross ratio by connecting the cross ratios derived between the homogeneous sensors.

### Effects of Invention

According to the present invention, a baseline for a measurement can be determined using a cross ratio, which is a geometric relationship between a signal generated by a source and a sensor measuring the signal, and a sharp change in the signal can be detected.

### BRIEF DESCRIPTION OF DRAWINGS

Hereinafter, embodiments of the invention will be described with reference to the accompanying drawings. For the purpose of easy understanding of the invention, the same elements will be referred to by the same reference signs. Configurations illustrated in the drawings are examples for describing the invention, and do not restrict the scope of the invention. Particularly, in the drawings, some elements are slightly exaggerated for the purpose of easy understanding of the invention. Since the drawings are used to easily understand the invention, it should be noted that widths, depths, and the like of elements illustrated in the drawings might change at the time of actual implementation thereof. Meanwhile, throughout the detailed description of the invention, the same components are described with reference to the same reference numerals.

FIG. 1 exemplarily illustrates a cross ratio in a projection transformation, which is a geometric relationship applied to detect the difference in signals;

FIGS. 2A to 2E are diagrams that simplify the relationship between sources and sensors for deriving the cross ratio;

FIG. 3A is a schematic diagram illustrating state estimation, and FIG. 3B is a schematic diagram illustrating a device for detecting differences in signals between channels in a multi-channel receiver using a single frequency;

FIG. 4 is a flow chart illustrating a method for detecting a difference in signals by calculating a cross ratio with geometry information;

FIG. 5 exemplarily illustrates an observation model of a carrier measurement used to calculate a cross ratio;

FIG. 6 is a graph showing the cross ratio by input value used for CS detection;

FIG. 7 is a graph showing the moving average value by Doppler measurement;

FIG. 8 is a graph showing the carrier measurement including CS and the moving average Doppler measurement;

FIG. 9 is a graph showing an example of the cross ratio by CS magnitude;

FIG. 10 is a graph showing an example of a cross ratio set with a threshold of one wavelength;

FIG. 11 exemplarily illustrates the experimental results of the whole CS detection scenario when CS magnitudes are different;

FIG. 12 exemplarily illustrates the experimental results of the entire CS detection scenario in the case of the same and different CS magnitudes; and

FIG. 13 is a graph in which the cross ratios of FIG. 12 are superimposed with the single-differenced cross ratios.

### MODE FOR INVENTION

Embodiments which will be described below with reference to the accompanying drawings can be implemented singly or in combination with other embodiments. But this is not intended to limit the present invention to a certain embodiment, and it should be understood that all changes, modifications, equivalents or replacements within the spirits and scope of the present invention are included. Especially, any of functions, features, and/or embodiments can be implemented independently or jointly with other embodiments. Accordingly, it should be noted that the scope of the invention is not limited to the embodiments illustrated in the accompanying drawings.

Throughout the attached drawings, identical or similar elements are referenced using the same drawing reference numerals.

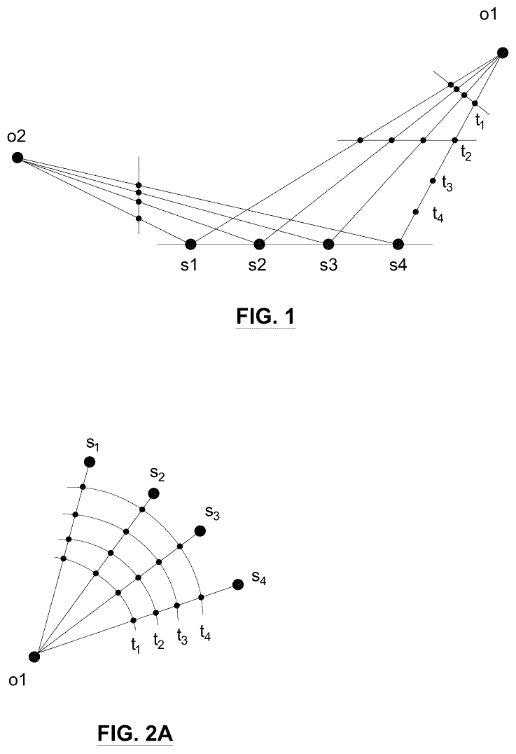

FIG. 1 exemplarily illustrates a cross ratio in a projection transformation, which is a geometric relationship applied to detect the difference in signals.

In urban areas, detecting CS, which is a difference in signal (or a sharp change in signal) using only one single frequency, is difficult because the position is unknown, requiring a consistency check technique or a position estimation. In general, the comparison target and method must be considered to detect an outlier. The comparison target can be a location domain or a temporal domain, and specifically, position values can be compared or change rates over time can be compared. The comparison method can be classified into a consistency check technique that compares multiple to single or a method that compares estimated values to observed values. In the field of satellite navigation, the position is determined by triangulation using measurements, so detection is performed by dividing it into a location-based domain and a distance-based domain in terms of the comparison target.

In order to detect CS independently for each channel, it must be performed in the distance-based domain, not the location-based domain, as the comparison target. The problem is that in order to detect an anomaly in a channel, a comparison target is needed, such as the consistency check technique, and the sharp change can be detected through the signal ratio. In order to detect each channel as a ratio, a decision baseline is required, and the cross ratio, which is invariant in the projection transformation in the geometry, can be the baseline. The invariance of the cross ratio can suggest that the ratio of all channels is the same, and also enables threshold setting according to the CS magnitude.

Homography refers to a certain transformation relationship that is established between the corresponding projected points when one plane is projected onto another plane, and in computer vision, planar homography represents the transformation relationship between points on the plane. The geometry applied to computer vision can be applied to satellite navigation receivers as well. Since GPS satellites are far away compared to the distance between receivers when the carrier is single-differenced, they can be considered as points on the plane. The carrier measurement of each satellite can be treated as a camera capturing points on a plane, and the transformation relationship between the points captured by the two cameras can be considered as a single-differenced carrier measurement. In other words, the transformation relationship between the same points captured by the two cameras is a planar homography and has the properties of projective geometry. In projective geometry, the anharmonic ratio or double ratio can be defined as the unique projective invariant of four points on the same line.

Referring to FIG. 1, four groups of collinear points are shown, and each group represents a projection transformation between lines. If the four dotted lines are placed on the time axis, the relationship between the points, which is the rate of change between the carrier measurements, has the same cross ratio value for all channels. This means that the cross ratio is invariant during the projection transformation and the cross ratios between each point are the same. In this way, each channel can be detected individually and the consistency check between channels can be performed. In addition, since it is independent of the base distance and detects the rate of change, the resolution can be increased depending on the quality of the signal itself. The cross ratio (z₁, z₂, z₃, z₄) of four points z₁, z₂, z₃ and z₄ on the same real or complex line is as follows.

$$( {z}_{1} , {z}_{2} ; {z}_{3} , {z}_{4} ) = \frac{( {z}_{1} - {z}_{3} ) ( {z}_{2} - {z}_{4} )}{( {z}_{2} - {z}_{3} ) ( {z}_{1} - {z}_{4} )} = λ \qquad Equation 1$$

Where, (z₁−z₂) denotes the distance between two points in one dimension, and the order of z₁, z₂, z₃ and z₄ can be changed. When the comparison target is the temporal domain, four or more temporal points in the measurements can be used to detect anomalies in time, and if the comparison is in the spatial domain, four or more spatial points on a straight line can be used to detect anomalies in space. The sharp changes in the temporal and spatial cross ratios appear in the same form.

Similar to the cross ratio in the spatial domain, the cross ratio λ in the temporal domain is derived from the measurements for each time period (t₁ to t₄) on the straight line between the target o₁ and sensors s₁ to s₄. If the measurement generated by sensor s₁ at time t is A (t), the measurement generated by sensor s₂ at time t is B (t), and C (t) is defined as the difference between A (t) and B (t), that is, A (t)−B (t), then the cross ratio in the temporal domain can be calculated as follows. Instead of the cross ratio λ, it is also possible to use six cross ratios (anharmonic ratios) such as λ, 1/λ, 1−λ, 1/(1−λ), λ/(λ−1), (λ−1)/λ by changing the order of the points.

$$λ = \frac{( C ( {t}_{1} ) - C ( {t}_{2} ) ) C ( {t}_{2} ) - C ( {t}_{4} ) )}{( C ( {t}_{1} ) - C ( {t}_{3} ) ) C ( {t}_{1} ) - C ( {t}_{4} ) )} \qquad Equation 2$$

The cross ratio λ derived in the temporal domain for a single signal is a change in change, and since it corresponds to a sharp change in time, it is possible to distinguish outliers by setting a certain threshold value. In addition, since the cross ratios λ between sensors s₁ to s₄ are relatively similar, they can be distinguished through the difference in the cross ratios between them. In theory, the geometric relationship between sensors s₁ to s₄ belongs to a projection transformation, so they have the same cross ratio λ, but they do not exactly match due to signal noise and errors.

On the other hand, the cross ratio λ in the spatial domain is the slope of the slope according to the structure and shape of the same time zone. For example, the cross ratio λ between the four intersections where the t₂ line touches the straight lines s₁ to s₄ is obtained. The cross ratio λ obtained through the four intersections indicates the curvature between sensor s₁ and sensor s₄, therefore it indicates the boundary between two areas with different characteristics in the case of the image.

Unlike the cross ratio calculated in the temporal domain, the cross ratio calculated in the spatial domain belongs to the same time zone. Therefore, the cross ratio λ in the spatial domain can be used to distinguish two images by comparing information from two images or by comparing the cross ratio with a straight line in one image.

The cross ratio, which combines the temporal domain and the spatial domain, can be applied to time series structure analysis, and so on.

Sharp changes in the cross ratio in the spatial domain and the cross ratio in the temporal domain appear in the same form. The cross ratio in the spatial domain can be derived by Laplace convolution. Applying Laplace convolution performs a convolution operation through a window of a certain size, and can obtain the value more easily than calculating the value for each pixel. For example, it can obtain the boundary where sharp changes occur in an image. The cross ratio in the temporal domain can be directly derived by an arithmetic operation. This is a kind of ratio value of a ratio, which is a ratio of speed that is a ratio in time, it can be regarded as acceleration.

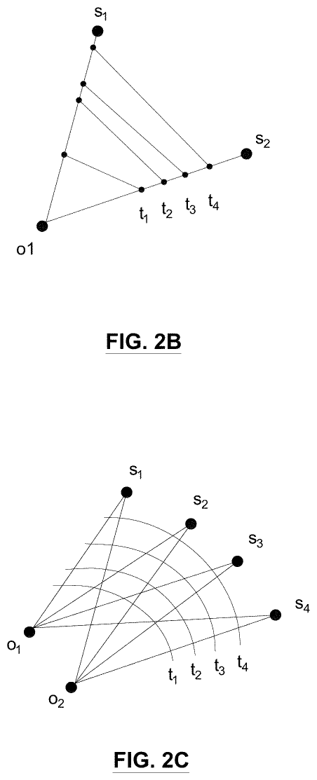

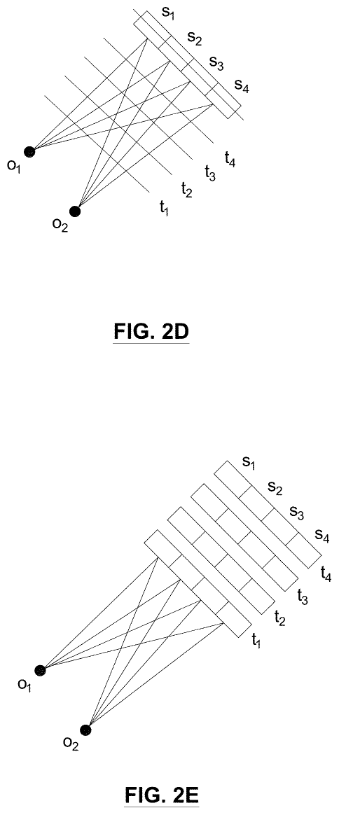

FIGS. 2a to 2e are diagrams that simplify the relationship between sources and sensors for deriving the cross ratio. The source and sensor can be replaced, and for convenience of explanation, the source is represented as o and the sensor as s.

In the case of a single source and a single sensor relationship, for example, if a RADAR/LiDAR consists of one pixel or a GPS satellite is one, the measurement is a scalar. In this case, a sharp change can be detected in the temporal domain through four or more time series measurements. On the other hand, in the case of an image sensor that can generate a vector image, the measurement is a vector. In this case, a sharp change can be detected in the temporal domain, and a boundary, which is a sharp change, can be derived in the spatial domain.

In the case of multi-sources and a single sensor relationship, for example, if it is a RADAR/LiDAR or a GNSS receiver, the measurement is a vector. In this case, in the temporal domain, a sharp change can be detected through four or more time series measurements per source. Meanwhile, in the spatial domain, a sharp change boundary can be derived through four or more points on a straight line.

In the case of a single source and multi-sensor relationship, the measurement is a single differenced vector. The number of sensors can be four or more. In this case, in the temporal domain, a sharp change can be detected through four or more time series measurements per sensor. Meanwhile, in the spatial domain, a sharp change boundary can be derived through four or more points on a straight line.

In the case of a multi-source and multi-sensor relationship, the measurement is a double differenced vector. The number of sources can be two or more, and the number of sensors can be four or more. In this case, in the temporal domain, a sharp change can be detected through four or more time series measurements per source. Meanwhile, in the spatial domain, a sharp change boundary can be derived through four or more points on a straight line.

Referring to FIG. 2A, a simplified form for obtaining the temporal domain and spatial domain cross ratios between one source o¹ and multiple sensors s₁ to s₄ is illustrated. In the temporal domain, the cross ratio can be calculated from measurements from time t₁ to t₄, and in the spatial domain, the cross ratio can be calculated from measurements of sensors s₁ to s₄ included in the same line at one point in time, for example, t₁. In FIG. 2, the lines representing the same point in time are expressed as a curve, but all measurements in space are mathematically orthogonal at each point in time, so they lie on a straight line.

The measurement is minimized only with scalar quantities. That is, data in the form of vectors and arrays are broken down into individual scalars and distinguished as measurements.

Next, structures such as array antennas and image sensors are minimized on a pixel-by-pixel basis. Components of arrayed RADARS, LiDARs, and image sensors can be simplified into individual sensors. This can be replaced with a kind of multi-sensor (in the form of elements whose placement and position are organized). The integrated form of the arrayed sensors can be similar to the image sensor.

Next, a pair of information becomes a source or sensor. That is, a pair of information can be decomposed into three points, which can simplify the relationship between multiple sources and multiple sensors.

Referring to FIG. 2B, a simplified form is illustrated for obtaining the cross ratio λ between one source o1 and two sensors s1 and s2. The cross ratio λ calculated by applying Equation 1 in the relationship between a single source and multiple sensors can have the same value through the relationship between simplified figures as in FIG. 2B. Therefore, the same cross ratio is compared to derive the difference, and it is selected as the decision baseline for classification and prediction.

In detail, o₁ is selected as a source, and s1 and s2 are selected as sensors. Here, o₁−s₁ and o₁−s₂ are connected by radio waves, sound, light, etc., such as RADAR, LiDAR, GNSS, and image sensors.

In this relationship, each cross ratio is derived. That is, by obtaining the time-based measurements m(t₁), m(t₂), m(t₃) and m(t₄) of o₁−s₁ and o₁−s₂, the cross ratios λ, 1/λ, 1/(1−λ), λ/(λ−1) between the time-based measurements are calculated.

Since there is a triangular projection transformation relationship between measurements targeting the same source o₁, the cross ratios obtained for each measurement are the same.

The classification or prediction is decided based on the cross ratio that must be the same. The decision baseline can be determined by distinguishing the difference.

Referring to FIG. 2C, a simplified form is illustrated for obtaining the cross ratio λ between two sources o₁, o₂ and neck sensors s₁ to s₄. Compared to FIG. 2A, FIG. 2C shows the relationship with the source o₂ added. As illustrated, in the case of multiple sensors and multiple sources, instead of calculating the entirety at once, it may be decomposed into several components of triangle, and then each cross ratio may be obtained.

Referring to FIG. 2D and FIG. 2E, the cross ratio can be calculated from the image sensor or phased array antenna, in which multiple sensors are arranged to have a certain positional relationship. The cross ratio can be calculated for each sensor by decomposing it into components of a triangle, which is the smallest unit.

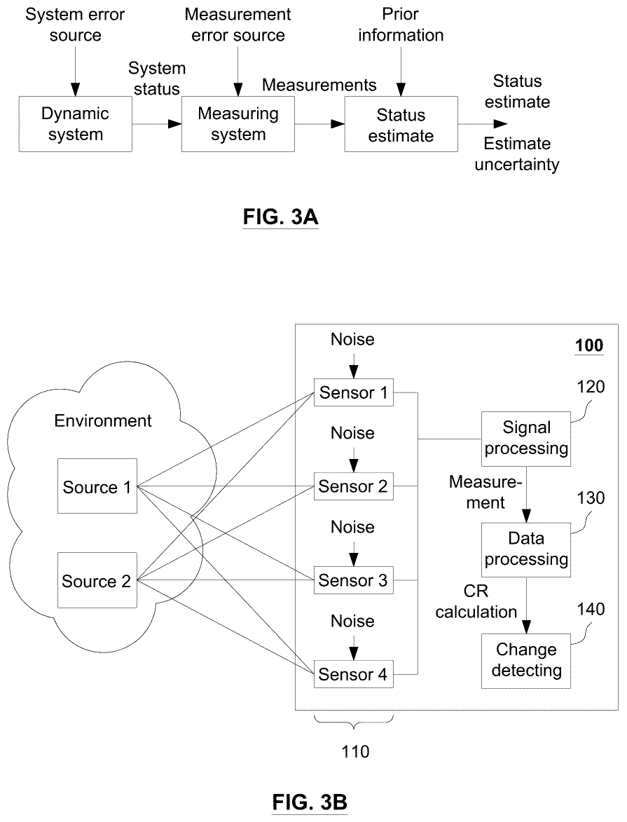

FIG. 3A is a schematic diagram illustrating state estimation, and FIG. 3B is a schematic diagram illustrating a device for detecting differences in signals between channels in a multi-channel receiver using a single frequency.

### Estimation, Decision, and Tracking

Estimation is the process of inferring the value of a quantity of interest from indirect, imprecise, and uncertain observations. M ore strictly speaking, estimation can be viewed as a “best guess”, a process of selecting a point in a continuous space.

Decision is the selection of one of a set of distinct alternatives. In other words, a “best choice” in a discrete space. The classification of an object is a decision. One can talk about estimation not as a choice, but as a case of discrete values where some conditional probabilities of various alternatives are likely to be obtained. This information can be used without making a “hard decision.”

Estimation and decision can be viewed as overlapping, and techniques from both areas are used simultaneously in many real-world problems.

Tracking is the estimation of the state of a moving object based on remote measurement. This is done using one or more sensors at a fixed position or on a moving platform. Tracking is broader than estimation. It requires extensive use of statistical decision theory, as well as all the tools and techniques of estimation. In particular, real-world problems such as some data associations are also considered.

Filtering is the estimation of the (current) state of a dynamic system from noisy data. This is equivalent to “filtering” the noise. The reason for the use of the word “filter” is that it is the process of obtaining the best estimate by “filtering out” the noise from noisy data. The term filtering is used in the sense of removing non-ideal signals (in this case, noise).

In a control system, signals are filtered to estimate the state of a dynamic system (including noise) that the controller requires. Signal filtering is commonly used in signal processing in the frequency domain and the spatial domain. For example, in the spatial domain, signals coming from a certain direction are selected.

Navigation is the estimation of the state of a platform where a sensor is located. Smoothing or retrodiction is the estimation of the state of a system at a time (or several times) before the current time.

In an estimation problem, the variables of interest are time-invariant parameters such as scalars, vectors, or matrices, and the state of the dynamic system, which is usually a vector.

FIG. 3A shows state estimation. Dynamic systems and measuring systems are “black boxes”, meaning that the variables inside them are inaccessible. The only variables available to the estimator are measurements, which are affected by error sources in the form of “noise.”

The estimator uses knowledge of the evolution of the variables (system dynamics), the sensors (measuring systems), the probabilistic nature of various random factors (errors or uncertainties), and prior information.

An optimal estimator is a computational algorithm that processes observations (measurements) to produce an estimate of the variable of interest that minimizes a certain error baseline. The advantage of the optimal estimator is that it makes the most of knowledge about the data, the system, and its distribution. The disadvantage is that it is sensitive to modeling errors and can be expensive.

Information fusion or data fusion is the process of combining data (raw or processed) from different sensors, i.e. multi-sensor data, to improve the final result, which can be an estimate or decision. While some scholars consider the combination of data from the same sensor at different times as fusion (in which case a simple Kalman filter is considered a “fuser”), data fusion can extend to the dimension of situational awareness.

### Surveillance Systems

The widespread use and sophistication of military and civilian surveillance systems have led to a great deal of interest in algorithms that can track a large number of targets using measurements from a variety of sensors. The high sensitivity of modern sensors and the need to work in low SNR environments can result in a huge data load, and the presence of countermeasures can further increase the difficulty of tracking. Moreover, the tracking effort for n targets can be much more costly than the effort for a single target n times. This is due to the fact that establishing a match between targets and observations is not a trivial matter, but can be a complex combinatorial problem.

Regarding FIG. 3A, the connection between the dynamic system and the measuring system is not fully known. It deals with a remote sensor that detects energy emitted or reflected from a target/source (or multiple targets/sources) of interest, but there may be other spurious energy sources.

Advances in hardware and algorithms have increased the signal processing capabilities several orders of magnitude in recent years. This has made it possible to track much more numerous and complex measurements, and has created a need for advances in information processing technologies to handle them.

It has been recognized that when tracking a target, there may be additional uncertainty associated with the measurement, along with the inaccuracy typically modeled by some additional noise. This additional uncertainty is related to the source of the measurement. The measurement used in the tracking algorithm may not have originated from the target of interest.

This situation is one in which RADAR, SONAR (Sound of navigation and ranging), satellite navigation, or optical sensors measure clusters, countermeasures, false alarms, or multiple targets. Uncertainty in the origin of the measurement may arise when multiple targets are in the same proximity and can be resolved through observed detections, but cannot be associated with certainty about the target. A similar situation occurs in the track formation problem, where there are multiple targets but their number is unknown and some measurements may be spurious.

In a sense, the application of standard estimation algorithms that use measurement closest to the predicted measurement (the “nearest neighbor approach”) can lead to very poor results in environments where false measurements are common. This is because these approaches do not account for the fact that the measurements used in the algorithm may have originated from the target of interest.

### Tracking

Tracking is the processing of measurements obtained from a target to maintain an estimate of the current state, which typically consists of:
Kinematic components: position, velocity, acceleration, rotation rate, etc.
Characteristic components: radiated signal intensity, spectral characteristics, RADAR cross-section, target classification, etc.
Constant or slowly varying parameters: aerodynamic parameters, etc.

Measurements, on the other hand, are observations that are corrupted by noise related to the state of the target, such as:
Direct estimation of position (usually range, azimuth, and elevation)
Range/distance and azimuth (bearing) of the sensor
Bearing only at the sensor
Range/distance ratio (Doppler)
Time difference of arrival (TDOA) of the signal between the two sensors
Frequency of the narrowband signal emitted by the target (Doppler shift)
Frequency difference of arrival at the two sensors (Doppler difference)

The “raw” measurement of interest are typically the output of complex signal processing and detection subsystems, as shown in FIG. 3B.

Active sensors emit energy into the environment and detect reflected energy, while passive sensors detect energy emitted by the target of interest.

### Data Linking and Fusion

A track is an estimated state trajectory from a set of measurements (data associated with the same target).

The essentials of the multi-target problem is to perform this linking process, as uncertainty in the source of measurements arises due to:
Random false alarms during detection
Clutter due to spurious reflectors or emitters near the target of interest
Interfering targets
Decoy and countermeasures

Also, the probability of obtaining a measurement from a target (target detection probability) is generally less than unity.

Data linking problems can be classified according to their relevance:
Measurement to measurement association (M2MA): for track formation
Measurement to track association (M2TA): for track maintenance or update
Track to track association (T2TA): for track fusion (in multi-sensor systems)

Meanwhile, there are two fundamentally different approaches that can be used to link/correlate data.
Non-Bayesian data correlation: These approaches use discovery criteria such as distance or normalized distance, or statistical tools such as maximum likelihood or hypothesis testing, to perform the decision procedure. And once reaching the correlation decision, the fact that it is not guaranteed to be correct is ignored in the subsequent flow.
Probabilistic (Bayesian) data correlation: These approaches estimate the probability of correlation and use it throughout the estimation process.

Both of these approaches depend on specific models of the target and the sensor from which the measurements are taken.

There are significant challenges in modeling the abnormal behavior of a target that may exhibit different modes of behavior, i.e., targets that can maneuver. This complicates the already complex problem of correlating measurements under uncertainty.

The terms used in tracking and data linking/correlation can be defined as follows:
Sensor: A device that observes the (remote) environment by receiving some signal (energy).
Frame: A “snapshot” of the environment area acquired by the sensor at a specific point in time, called the sampling time (in practice this is an integration over a short period of time).
Scan: A series of snapshots, each of which is a specific area of space (e.g. defined by the solid angle of the sensor).
Signal processing: Processing of the sensor data to provide measurements (typically a single sampling time).
Signal detection: Threshold of the sensor data for further processing (typically a single sampling time).
Measurement formation (extraction): The final step in signal processing that generates measurements.
Measurement (observation, hit, return, report, plot, threshold exceeded): The estimated parameters of the detected signal.
Time stamp: The time associated with the detection/measurement. For scanning sensors, the detection-related time is within the scan interval, and for staring sensors, all detection times in a frame are the same.
Registration: The data can be combined by aligning two or more sensors or aligning sensor data moving at consecutive sampling times.
Track formation (or track assembly, target acquisition, measurement-to-measurement linking (M2MA), scan-to-scan linking): Target detection (processing measurements at multiple sampling times to determine the presence of the target) and tracking initiation (determining an initial estimate of the state).
Tracking filter: The state estimator of the target.
Data correlation/linking: The process of setting up measurements (or weighted combinations of measurements) to be used in the state estimator.
Track maintenance or update: Linking and integrating measurements from sampling times into the tracking filter.
Cluster tracking: Tracking a set of close targets as a group rather than individually.

Referring to FIG. 3B, a device 100 for detecting a difference in signals in multiple channels may include a plurality of sensors 110, a signal processing unit 120, a data processing unit 130, and a change detection unit 140.

The source and the sensor are linked through a signal. The signal may be any one of radio waves, light, and sound waves. In the relationship between the source and the sensor, the source does not necessarily have to generate a signal by itself. For example, if the source is a satellite belonging to a satellite navigation system, it outputs a radio wave including a code, but in the case of RADAR/LiDAR, the source may be a reflector that reflects the radio wave emitted by the RADAR/LiDAR.

The plurality of sensors 110 is configured for receiving signals from each of two or more sources and output raw time series measurements for each channel. The plurality of sensors 110 are arranged on the same plane, and the distances between the sensors 110 may be the same or different. The minimum number of sensors for calculating the cross ratio in the temporal domain may be two or more. Meanwhile, the minimum number of sensors for calculating the cross ratio in the spatial domain may be 4 or more.

One sensor 110 may distinguishably receive signals from two or more sources over two or more channels. Each of the plurality of sensors 110 receives a first signal from a first source through a first channel, and receives a second signal from a second source through a second channel. Since the plurality of sensors 110 arranged on the same plane have a relationship in which the first source and the second source are projected onto the plane, the first cross ratio calculated for the first channel and the second cross ratio calculated for the second channel may be substantially the same.

The sensor 110 may be a zero-order tensor or a first-order tensor. The measurement output by the zero-order tensor such as a GPS sensor or a sound wave sensor may be a scalar quantity. Meanwhile, the measurement output by a first-order tensor in which a plurality of sensors receiving signals, such as an image sensor, an array antenna, a LiDAR, etc., are arranged to have a geometric relationship may be a vector. Meanwhile, some of the multiple sensors may be homogeneous sensors, and the rest may be heterogeneous sensors. Since the distance, position, direction, speed, and so on for the same source are applied equally to the heterogeneous sensors, the cross ratio substantially the same as that between homogeneous sensors can be calculated.

The signal processing unit 120 is configured for process and output the raw time series measurements for each channel output by each of the plurality of sensors 110 so as to be suitable for calculating the cross ratio. For example, the signal processing unit 120 is configured for generating a processed time series measurement by single-differencing, double-differencing, or triple-differencing the time series measurement. The differencing may be performed using the geometric relationship between the source and the sensor, and may be any one of inter-sensor differencing, inter-source differencing, and time differencing. Therefore, if double-differencing or more is performed, the time series measurement may be differenced in each of the spatial domain and the temporal domain, or in both domains. For example, the double-differenced time series measurement indicates a change in the change of the signal, and the example described below calculates the cross ratio using this.

The data processing unit 130 is configured for calculating the cross ratio using the raw or processed time series measurements and the estimated value through estimation. The cross ratio in the temporal domain can be calculated for each channel using the difference between the differenced time series measurements, and one of the various calculation methods is an arithmetic operation as in Equation 2. Meanwhile, as can be confirmed through the examples below, the cross ratio is determined through the geometric relationship between the source and the sensor, and since the raw time series measurements may include errors and/or noises due to various causes, the cross ratios calculated from all of the raw time series measurements, the single-differenced time series measurements, the double-differenced time series measurements, and the triple-differenced time series measurements can substantially increase or decrease around the same value. The cross ratio can vary depending on the type of the source, sensor, and/or signal. Further, as the number of differences increases, the increment or decrement of the cross ratio may decrease. Additionally or optionally, the signal processing unit 120 may be configured for performing an estimation such as moving average filtering to remove noise from the processed time series measurements.

The data processing unit 130 is configured for connecting data between the plurality of sensors 110. The data processing unit 130 may be configured for generating a signal difference as a first channel-specific cross ratio derived through raw or processed time series measurements, a signal difference as a second channel-specific cross ratio derived through estimation from raw or processed time series measurements, and a signal difference as a third channel-specific cross ratio that combines raw or processed time series measurements and estimation. The first to third channel-specific cross ratios can be complementarily stored for comparison by multiple channels. The data processing unit 130 may be configured for complementarily connecting a cross ratio calculated for a homogeneous sensor among the plurality of sensors 110 and a cross ratio calculated for heterogeneous sensors among the plurality of sensors.

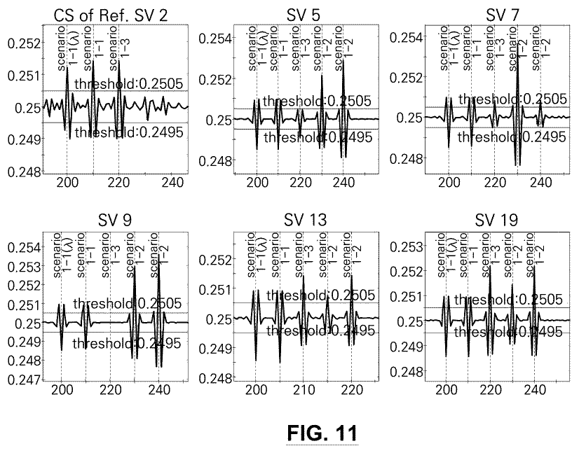

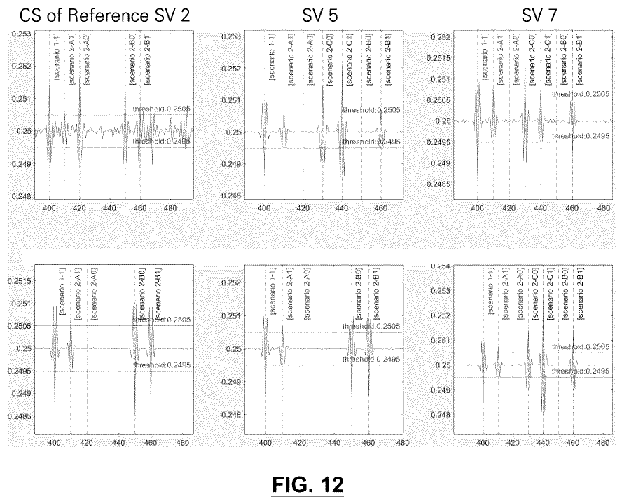

The change detection unit 140 is configured for detecting a signal difference in the cross ratios calculated by each channel. A sharp change in the cross ratio may indicate that the cross ratio at a specific point in time is greater than the cross ratio calculated at a close point in time in the channel-specific cross ratio calculated in time series. For example, a sharp change in a signal detected in the temporal domain may be CS, and a sharp change in a signal detected in the spatial domain may be a boundary. A scenario in which CS occurs in multiple channels and is detected will be described below with reference to FIGS. 11 and 12.

Additionally or optionally, the change detection unit 140 may be configured for detecting a difference in a signal by applying a threshold to the cross ratio. The threshold may be determined experimentally or statistically depending on the magnitude of the signal difference to be detected. For example, the magnitude of the signal difference and the cross ratio have a substantially proportional relationship. However, if the threshold is set smaller than the incremental range of the cross rate in the normal range, the probability of false positives may increase. Meanwhile, the threshold may be set differently depending on the number of differencing. For a signal difference of the same magnitude, the number of differencing and the cross ratio have a substantially inverse relationship.

Additionally, or optionally, the change detection unit 140 may be configured for detecting a difference in a signal by using two or more cross ratios calculated using two or more differenced time series measurements with different number of differencing. CS detection using the first cross ratio derived from single-differenced time series measurements and the second cross ratio derived from double-differenced time series measurements will be described below with reference to FIG. 12.

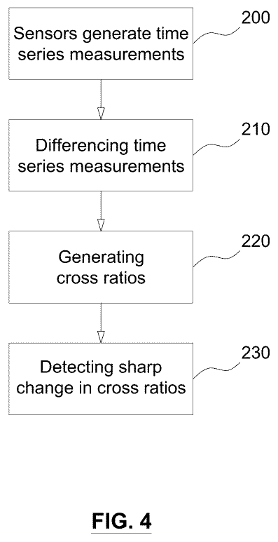

FIG. 4 is a flow chart illustrating a method for detecting a difference in signals by calculating a cross ratio. The method for detecting a difference in signals by calculating a cross ratio can be implemented as a computer program running on an electronic information processing device including a processor and a memory, for example, a computer.

In step 200, a plurality of sensors arranged in a straight line provide measurements at a plurality of points in time. The sensors are multi-channel sensors that each receive signals from two or more sources, and output measurements at, at least, four points in time for each channel. For signals received from the same source, the plurality of sensors simultaneously output measurements at each point in time, and are referred to as raw time series measurements per channel (hereinafter, raw time series measurements).

In step 210, the raw time series measurements output by each of the plurality of sensors are processed. The time series measurements can be single-differenced, double-differenced, or triple-differenced. The differencing can be performed in either or both of the spatial domain and the temporal domain. Additionally or optionally, the processed time series measurements can be estimated, such as by moving average filtering.

In step 220, the cross ratio is calculated for each channel using the processed time series measurements. In order to calculate the cross ratio for each channel, one source and two sensors are selected, and the cross ratio can be calculated using the processed time series measurements output from the selected sources. In the case of the first to fourth sensors, two sensors can be selected from among them to calculate the cross ratio, or the cross ratio can be calculated for all sensor pairs that can be combined.

In step 230, a sharp change is detected in the cross ratio calculated for each channel. The cross ratio calculated for each channel varies within a certain range due to errors and/or noise, but on average or statistically fluctuates around the same value. The cross ratio applied to the decision of a sharp change refers to a baseline determined experimentally or statistically.

A sharp change that represents a sharp change rate in the temporal domain and a boundary in the spatial domain can be detected for each channel using a threshold. The threshold can be determined experimentally or statistically depending on the magnitude of the sharp change to be detected, and can be determined differently for each channel and/or the number of differencing. In a system that uses radio waves as signals, a threshold can be set for each change size, so that the change and change rate corresponding to the sharp change detected in a specific channel can be determined.

Hereinafter, a satellite navigation system will be used as an example of an application field that can detect a sharp change in a signal such as CS.

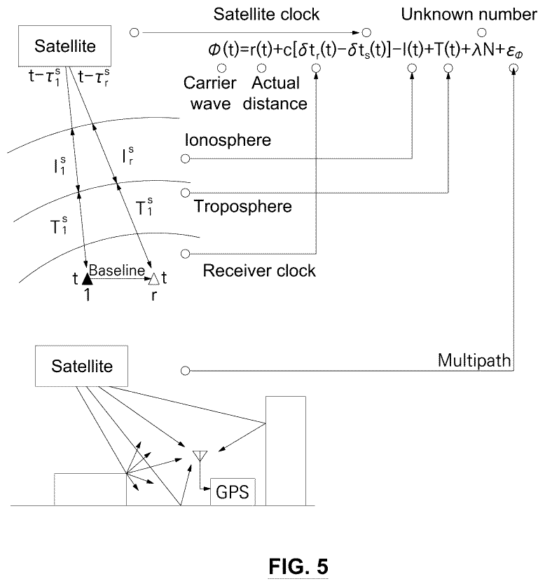

FIG. 5 exemplarily illustrates an observation model of a carrier measurement used to calculate a cross ratio.

### GPS Observation Model

Looking at the carrier measurements and the measurement models for single difference, double difference, and triple difference, they are shown in Equation 3. Equation 3 is an observation model of a carrier measurement.

$$ϕ ( t ) = r ( t ) + c [ δ {t}_{r} ( t ) - δ {t}_{s} ( t ) ] - I ( t ) + T ( t ) + λ N + {ϵ}_{ϕ} \qquad Equation 3$$

Where, ϕ is the carrier measurement (m) between the satellite and the receiver, λ is the carrier wavelength, N is an unknown number, r is the actual distance between the satellite and the reception time (m), c is the speed of light (m/s), δtᵣ(t) is the receiver time bias (sec), δtₛ(t) is the satellite time bias (sec), I is the ionospheric delay (m), T is the troposphere delay (m), and ϵ_{ϕ} is the receiver measurement noise and multipath and modeling error (m).

On the other hand, the Doppler measurement has the following relationship.

$${f}_{d} = - \frac{\dot{r}}{λ} \qquad Equation 4$$

Here, f_{d} is the observed Doppler shift, and f_{d} is the line-of-sight change rate.

Single, double, and triple differencing the observation model of the carrier measurements is equivalent to Equation 5 through Equation 7.

$$Δϕ = Δ r + Δτ + Δ T - Δ I + λΔ N + {ϵ}_{Δϕ} \qquad Equation 5$$

Where, Δ is the receiver-to-receiver difference, and r is the receiver-to-receiver time bias, which is equal to cδtᵣ.

$$∇ Δϕ = ∇ Δ r + ∇ Δ T - ∇ Δ I + λ ∇ Δ N + {ϵ}_{∇ Δϕ} \qquad Equation 6$$

Where, ∇ is the satellite-to-satellite difference.

$$∇ Δ \dot{ϕ} = ∇ Δ \dot{r} + ∇ Δ \dot{T} - ∇ Δ \dot{I} + {ϵ}_{∇ Δϕ} \qquad Equation 7$$

Where, \dot{ϕ} is the time difference.

The satellite and receiver time errors can be removed through double difference, and it can be seen that the unknown number N is removed through time difference. If the observation model is converted to the user position, it is as follows.

$${ϕ}_{dd} ( t ) = {e}^{i} ( t ) \cdot ( {x}_{u} ( t ) - {x}_{r} ( t ) ) + {T}_{dd} ( t ) - {I}_{dd} ( t ) + λ {N}_{dd} + {ϵ}_{ϕ dd} \qquad Equation 8$$

Here, ϕ_{dd} is equal to the double differenced carrier measurement ∇Δϕ, eⁱ is the double differenced LOS vector, xᵤ is the user position, and xᵣ is the base station position.

To simplify the expression, the subscript dd used later, such as ϕ_{dd}, is removed, and ϕ is set as the double differenced value, and a clear expression is used when necessary. In addition, the unknown number expressed in the following means the unknown number in the distance unit multiplied by λ.

### Doppler and Carrier Change Rate Model

In the above observation model, the situation of one epoch is expressed as follows. This shows that the change in the user's position compared to the change in the satellite in the future greatly affects the measurement. If Equations 6 and 8 are substituted, the following is obtained.

$$N = e \cdot x + ( T - I ) - ϕ + v \qquad Equation 9$$

Where x(=xᵤ−xᵣ) is the distance vector between the user and the base station.

If Equation 9 is differentiated with an unknown number, the following is obtained.

$$CS = dN = e \cdot Δ x + Δ e \cdot x + Δ ( T - I ) - Δϕ + Δϵ \qquad Equation 10$$

Where, eₖ₋₁=eₖ−Δeₖ is expressed in units of the satellite change rate Δeₖ.

If the sampling is set to every second and CS occurs at an instant, the following is obtained.

$$CS = {e}_{k} \cdot {x}_{k} - {e}_{k - 1} \cdot {x}_{k - 1} + Δ ( T - I ) - Δϕ + Δϵ = {e}_{k} \cdot Δ {x}_{k} - Δ {e}_{k} \cdot {x}_{k - 1} + Δ ( T - I ) - Δϕ + Δϵ \qquad Equation 11$$

Where, Δxₖ=xₖ−xₖ₋₁ is the change in the user's position.

Since the ionosphere and troposphere errors can be ignored when sampling at 1-second intervals, if Δeₖ·xₖ₋₁ is replaced with εₖ in Equation 11, the following small change value can be calculated.

$${ε}_{k} = Δ {e}_{k} \cdot {x}_{k - 1} \approx \frac{3.89 km / s \times 1 s \times 10 m}{2 \; 0200 km} \approx 0.0 \; 019 m \approx 0.01 cycle \qquad Equation 12$$

If the distance between the reference station and the satellite is set to approximately 20,200 km, the satellite speed (3.89 km/s), the pre-position error (10 m) (estimated by the code measurement), and the sampling at 1-second intervals are used, an error range of approximately 0.01 cycles is derived as above, and theoretically, it can be calculated as an observation error of 0.02 cycles in magnitude.

$${CS}_{k} = {e}_{k} \cdot Δ {x}_{k} + {ε}_{k} - Δϕ + Δϵ = 0 ( if no CS ) \qquad Equation 13$$

Equation 13 derived above means that the change in the measurement in a dynamic situation can be calculated as a pure user position change by setting the value due to satellite change as noise with a magnitude of 0.02 cycles.

The model equation for the relationship between the carrier measurement and the Doppler measurement can express the change rate of the above-described \dot{r} as the change rate of the carrier measurement as follows.

$${f}_{d} = \frac{\dot{ϕ}}{λ} \to \dot{ϕ} = λ {f}_{d} \qquad Equation 14$$

If the Doppler measurement at each moment is integrated, the carrier measurement can be estimated as follows.

$$\hat{ϕ} ( t ) = λ {\int }_{{t}_{0}}^{t} {f}_{d} dt \qquad Equation 15$$

If the carrier measurement is estimated using the discrete Doppler measurement, it is as follows.

$${\hat{ϕ}}_{k + 1} = {ϕ}_{k} + \frac{{\dot{ϕ}}_{k + 1} + {\dot{ϕ}}_{k}}{2} dt , {dN}_{k + 1} = {\hat{ϕ}}_{k + 1} - {ϕ}_{k + 1} \qquad Equation 16$$

As in Equation 16, if the Doppler average equation is set as the carrier estimation equation and the difference with the time-differenced carrier measurement is monitored using the characteristic of being insensitive to CS, the presence or absence of CS can be confirmed. Specifically, since it is a comparison method with the carrier estimation by Doppler measurement, if CS occurs as in Equation 13 by the difference between the carrier measurement change and the average Doppler measurement (i.e., the carrier change estimation) as in Equation 16, a change rate different from the existing one occurs in the channel. However, the Doppler measurement has a large error and noise depending on the receiver and dynamic state, so a solution is required for this. The Doppler measurement has different deviations depending on the receiver and varies greatly depending on the signal quality such as satellite altitude and C/N0. If the Doppler average value is used as in Equation 16, the weights for each altitude and receiver must be calculated and applied to the threshold. The detection of CS is performed by comparing the residuals between channels using the Least Square (LS), which can be complicated due to the statistical nature of LS, as the residuals change even for the same channel in dynamic conditions.

Therefore, in the embodiment described below, the double-differenced carrier measurement and the Doppler measurement (i.e., carrier estimate) with noise removed by the moving average filter are used as input values to remove the dominant errors and noise of the Doppler measurement. Specifically, the carrier measurement through double difference greatly reduces errors and noise, and in the case of the Doppler measurement, the receiver time error is removed through double difference and the measurement noise due to the dynamic situation is reduced through the moving average filter.

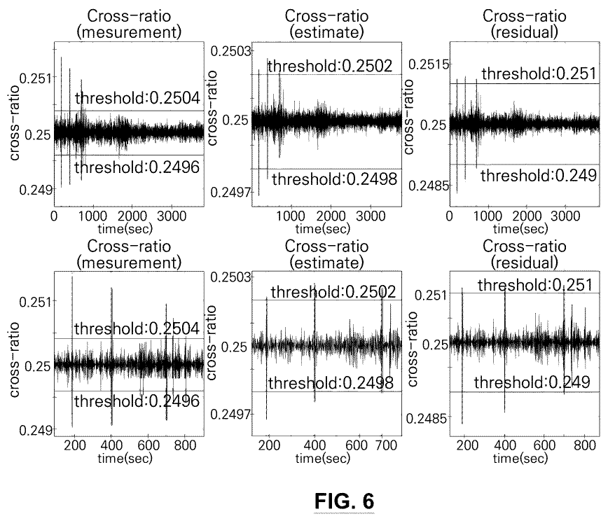

FIG. 6 is a graph showing the cross ratio by input value used for CS detection.

The application of the cross ratio to CS detection requires the selection of input values and the characterization of the resulting thresholds. The cross ratio is a concept derived from geometric principles, so it must be satisfied regardless of the base distance of the two receivers to be used. Therefore, the carrier and Doppler measurements at a relatively long distance of 22.5 km were used in the carrier difference technique.

As shown in FIG. 6, the characteristics of the combined measurements of the carrier and Doppler, the estimated values estimated by the Kalman filter using the measurements, and the residuals, which are the differences between the measurements and the estimated values, were analyzed in relation to the input values. In addition, since the measurements of the difference between the carrier and Doppler showed good results at a fixed error magnitude, it was found that it was reasonable to use the measurements (combined carrier and Doppler) without a specific estimation.

According to the analysis results related to threshold setting, the cross ratio was calculated to be the same as 0.25 for the results of the carrier measurement, the single-differenced carrier measurement, the double-differenced carrier measurement, and the triple-differenced carrier measurement combined with Doppler, and it was confirmed that the detection of CS of half a wavelength was possible using the triple-differenced carrier measurement combined with the Doppler measurement. The results for this can be found in Table 1.

TABLE 1

| | | Single- | Double- | Triple- |
|---|---|---|---|---|
| | | differenced | differenced | differenced |
| | Measurement | Measurement | Measurement | Measurement |
| Input | ϕ | (Δϕ) | (∇Δϕ) | (∇Δϕ − f_{d}) |
| Cross | 0.25 | 0.250.25 | | 0.25 |
| ratio | | | | |

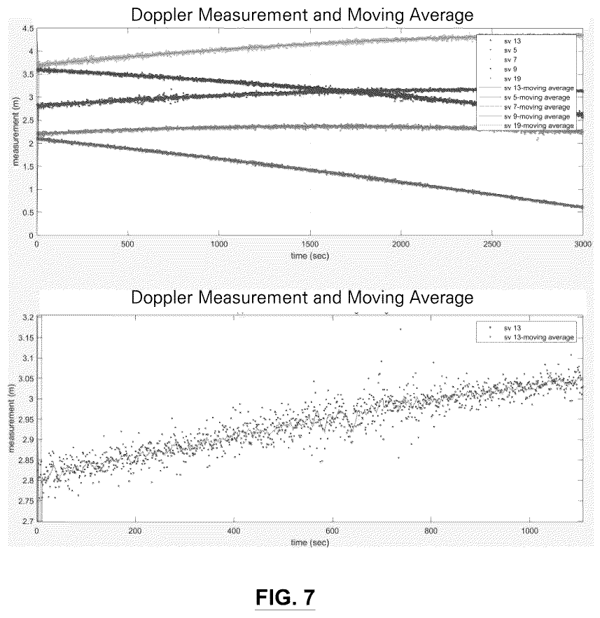

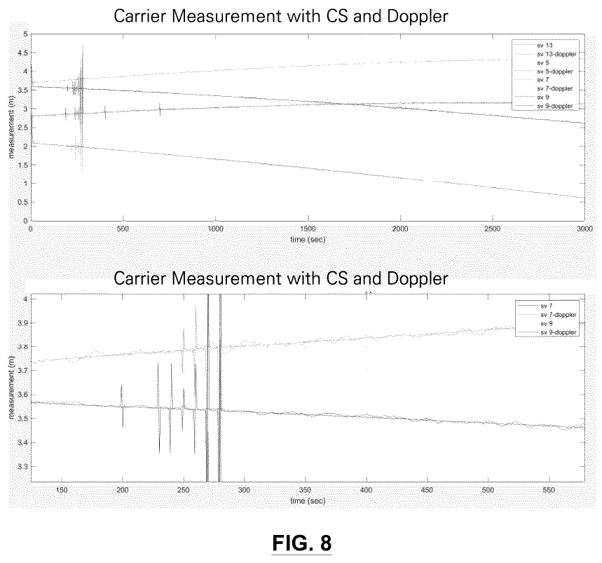

Referring to FIG. 6, for the comparison of input values, estimation of the measurement combining time-slow carrier and Doppler was performed using the Kalman filter. The residual size of the last column was derived as a result that can detect CS of half a wavelength. In addition, the threshold setting can also be directly specified as a desired size. However, the characteristics may change depending on the signal quality, and an estimation calculation is required to obtain the residual. Using a combined carrier and Doppler measurement is easier to calculate, but requires a threshold above a certain magnitude to avoid false detections due to noise. FIG. 7 is a graph showing the moving average value by Doppler measurement, and FIG. 8 is a graph showing the carrier measurement including CS and the moving average Doppler measurement.

When using the measurement of the carrier and the measurement of the Doppler, the dominant noise factor is due to the Doppler measurement, and if the moving average is used instead of the average between two epochs of the existing Doppler measurement, a Doppler measurement of better quality can be obtained. Referring to FIG. 7, it can be seen that the 10-second interval moving average carrier estimate is an improvement over the 2-second interval moving average. Referring to FIG. 7, the results of the carrier measurement with CS and the moving average Doppler measurement show that the two signals are matched without bias.

The following describes the analysis results using the Doppler measurement with noise removed by the moving average filter.

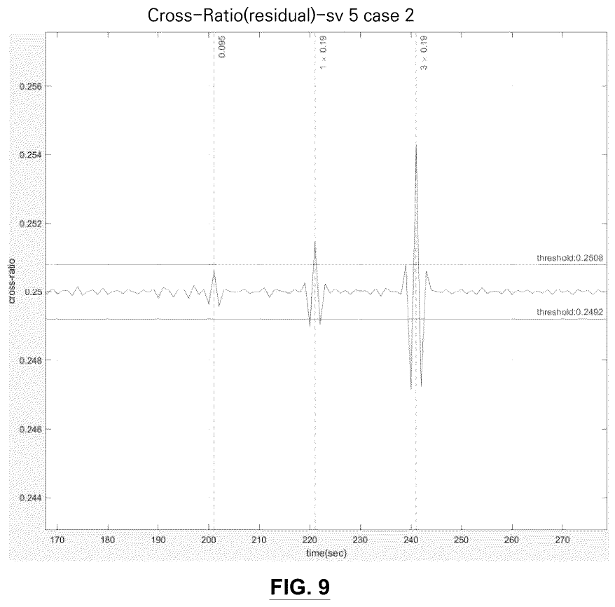

FIG. 9 is a graph showing an example of the cross ratio by CS magnitude.

When setting the threshold, it can optionally be determined whether the threshold is based on the CS magnitude and whether the set threshold is fixed.

Due to the nature of the cross ratio, qualitative analysis is difficult when determining the threshold, so quantitative analysis is required. Specifically, this is because the cross ratio remains the same even if the input value changes, but the threshold magnitude is determined according to the relationship between the CS length and the signal noise. Referring to FIG. 8, the threshold is set to 0.2508. The threshold is an arbitrary value set for channel-specific CS detection, and when applied, CS of one wavelength occurring near 220 seconds on the time scale and CS of three wavelengths occurring near 240 seconds are detected, but CS of half a wavelength occurring near 200 seconds is not detected. In the measurement of satellite 5, the cross ratio of CS of one wavelength is 0.25149 and the cross ratio of CS of three wavelengths is 0.25428, which shows that the ratio value increases with the CS magnitude.

The cross ratio is a ratio value of signal change and is correlated with the signal noise magnitude and threshold, and if the signal noise is large, the detectable threshold should also increase. Referring to FIG. 6 again, it shows that the detectable threshold is different depending on the carrier measurement combined with Doppler or the residual when the CS of one wavelength occurs on satellite channel 13. In the case of the measurement combined with Doppler and carrier, the threshold must be set to 0.2504 and the Kalman filter estimate must be set to 0.2502 to enable detection. To solve this problem, the noise of the signal must be reduced or the detectable threshold must be increased. In other words, a threshold that can be fixed regardless of the channel must be determined.

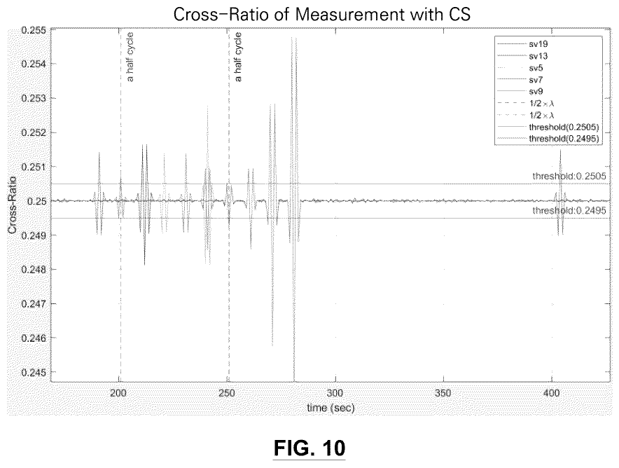

FIG. 10 is a graph showing an example of a cross ratio set with a threshold of one wavelength.

Referring to FIG. 10, the result is obtained by subtracting a time-differenced carrier measurement from a moving average Doppler measurement using a moving average filter to remove noise from a Doppler measurement. As can be seen in FIG. 10, the cross ratio of a noise-removed signal can be thresholded by a half-wavelength length on any channel. The upper and lower limits of the set thresholds are 0.2505 and 0.2495, respectively.

The following describes a process of detecting CS occurrence on a channel-by-channel basis in a multichannel environment using a measurement generated by combining the double-differentiated carrier measurement and the moving average Doppler measurement described above.

Since the double-differenced carrier measurement is used when applied to GNSS, it is necessary to distinguish whether CS occurred in the reference satellite or in each channel. In general, due to the characteristics of the cross ratio, it is possible to distinguish whether CS occurred in the reference satellite or in each channel through the magnitude and direction of occurrence of CS. However, if CS occurs simultaneously with the same magnitude, various scenarios arise, so this needs to be verified. In the experiments, the scenarios were divided into two categories: the case where the CS magnitudes are assumed to be not equal and the case where it does not matter if they are equal.

### Non-Identical CS Magnitude Detection Scenario

The CS detection status can be categorized into CS detected in all channels and partially detected. In the case where CS is detected in all channels, it can be categorized by whether the CS magnitude is the same or not.

The non-identical CS magnitude detection scenario is based on the assumption that the same CS magnitude does not occur at the same time. This scenario is a situation where CS is detected in all channels, and can be distinguished by CS magnitude and direction of occurrence. The specific scenario is organized as shown in the Table 2.

TABLE 2

| | CS occurred in | CS occurred in | CS Detection |
|---|---|---|---|
| Scenario | reference satellite | all channels | (magnitude/direction) |
| 1-1 | ◯ (all) | X (no) | ◯ (all)(same |
| | | | magnitude/direction) |
| 1-2 | X (no) | ◯ (all) | ◯ (all)(different |
| | | | magnitude) |
| 1-3 | ◯ (all) | ◯ (all) | ◯ (all) |

Scenarios 1-1 to 1-3 are possible cases where CS occurs in the reference satellite (i.e., source) or all channels (i.e., sensor), and can be distinguished by CS characteristics. The overall CS detection status can be distinguished by the possibility of CS occurring in the reference satellite or in all channels except the reference satellite. Scenario 1-1 is a situation where CS occurs only in the reference satellite, and the CS detection status is the result of occurrence in all channels. Scenario 1-2 is a situation where CS occurs in all channels except for the reference satellite, and Scenario 1-3 is a situation where CS occurs simultaneously in the reference satellite and all channels. The CS inputs and times of different magnitudes for each channel are as shown in Table 3. FIG. 11 exemplarily illustrates the experimental results of the whole CS detection scenario when CS magnitudes are different.

TABLE 3

| epoch | 200 | 210 | 220 | 230 | 240 |
|---|---|---|---|---|---|
| Reference | λ | λ | λ | — | — |
| satellite 2 | | | | | |
| Satellite 5 | — | — | 1/2 × λ | 3/2 × λ | 4/2 × λ |
| Satellite 7 | — | — | 3/2 × λ | 5/2 × λ | 1/2 × λ |
| Satellite 9 | — | — | 2/2 × λ | 4/2 × λ | 5/2 × λ |
| Satellite 13 | — | — | 4/2 × λ | 1/2 × λ | 2/2 × λ |
| Satellite 19 | — | — | 5/2 × λ | 1/2 × λ | 3/2 × λ |

Referring to FIG. 11, the double-differenced Doppler measurements received from reference satellite 2, satellite 5, and satellite 7 from the upper left to the right, and satellite 9, satellite 13, and satellite 19 from the lower left to the right are shown. Referring to FIG. 11 and Table 3 together, if all CS detection magnitudes are the same and exceed the threshold in the same direction, it can be distinguished as a situation where CS occurs only in the reference satellite as in Scenario 1-1, and a situation where CS magnitudes are different and occur simultaneously in all channels as in Scenario 1-2 and 1-3. In the case of Scenario 1-1, it can be confirmed that CS occurs in all channels with the same magnitude and direction in a situation where CS occurs only in the reference satellite at 200 and 210 seconds. In the case of Scenario 1-2, CS occurring with different magnitudes at 230 and 240 seconds can be detected. In the case of Scenario 1-3, CS occurs in all channels and the reference satellite at 220 seconds, and CS can be detected in different directions and magnitudes except for satellite 9. Satellite 9 has the same CS magnitude, which corresponds to the same CS magnitude detection scenario.

### Same CS Magnitude Detection Scenario

Partial CS detection is a common situation that does not require the assumption of non-identical CS magnitudes as above, and the scenario can be organized as shown in the table below.

TABLE 4

| | Reference | CS occurrence | | |
|---|---|---|---|---|
| Scenario | Satellite | in all channels | CS detection | CS magnitude |
| 2-A0 | ◯ | ◯ | Δ(Partial) | Same |
| 2-B0 | ◯ | Δ(Partial) | Δ(Partial) | Same |
| 2-C0 | X | Δ(Partial) | Δ(Partial) | Same |
| 2-A1 | ◯ | ◯ | Δ(Partial) | Different |
| 2-B1 | ◯ | Δ(Partial) | Δ(Partial) | Different |
| 2-C1 | ◯ | Δ(Partial) | Δ(Partial) | Different |

The above scenario is a situation where there is no assumption about CS magnitude, and it also includes a situation where CS detection occurs in all channels. Based on the worst case, it is possible for CS to be detected in partial channels or not detected. Regarding the scenario numbers, 2 is to distinguish from assumption 1, where the CS sizes are non-identical, and A˜C is to distinguish between the presence or absence of CS on the reference satellite and the presence or absence of CS in all or partial channels. 0 and 1 after the letters A˜C indicate equal and unequal CS magnitudes, respectively. Scenario 2-A0 indicates that the CS of the same magnitude occurs simultaneously in the reference satellite and all channels, and 2-A1 indicates the case where the CS magnitude is different in the same situation.

The CS input and time of the same and different magnitudes by channel are as shown in Table 5. FIG. 12 exemplarily illustrates the experimental results of the entire CS detection scenario in the case of the same and different CS magnitudes.

TABLE 5

| epoch | 400 | 410 | 420 | 430 | 440 | 450 | 460 |
|---|---|---|---|---|---|---|---|
| Reference | λ | 1/2 × λ | λ | | | λ | λ |
| satellite 2 | | | | | | | |
| Satellite 5 | | λ | λ | λ | 3/2 × λ | λ | 2/2 × λ |
| Satellite 7 | | λ | λ | λ | 1/2 × λ | λ | 1/2 × λ |
| Satellite 9 | | λ | λ | | | | |
| Satellite 13 | | λ | λ | | | | |
| Satellite 19 | | λ | λ | λ | 4/2 × λ | λ | 4/2 × λ |

Referring to FIG. 12, from the upper left to the right, the reference satellite 2, satellite 5, satellite 7, and from the lower left to the right, satellite 9, satellite 13, and satellite 19 are shown as double-differenced Doppler measurements. This will be explained with reference to FIG. 12 and Table 5 together. Scenarios 2-A0 and 2-A1 are situations where CS occurs simultaneously in all channels. In the case of 2-A0, where CS has the same magnitude, CS is not detected in all channels. However, if the CS of the reference satellite is half-wavelength, it can be confirmed that it is detected in all channels. Scenarios 2-B0 and 2-B1 are situations where CS occurs on the reference satellite and some channels. In 2-B0, CS is not detected in the channel where CS occurs, but is detected by the reference satellite in the channel where CS does not occur, resulting in an unexpected result. In the case of 2-B1, where CS magnitudes are different, CS of different magnitudes and directions is detected in all channels.

Scenarios 2-C0 and 2-C1 are situations where CS occurs only in some channels, and it is detected only in the channel where it occurs.

The scenarios are categorized according to the CS detected at each time point as follows.

TABLE 6

| epoch | 400 | 410 | 420 | 430 | 440 | 450 | 460 |
|---|---|---|---|---|---|---|---|
| Scenario | 1-1 | 2-A1 | 2-A0 | 2-C0 | 2-C1 | 2-B0 | 2-B1 |

As can be seen from the scenario results, it can be confirmed that the channel where CS is detected does not match the channel where it occurred. For situations where all, some, or no CS is detected, additional verification procedures are required to detect CS for each channel, including the reference satellite. The cross ratio of single difference can be used as an additional detection technique. In the case of single difference, the threshold setting can be larger than that of double difference, but as can be seen from the following experimental results, the threshold setting is not important because only the trend needs to be confirmed.

Complement when Detecting CS on Partial Channels

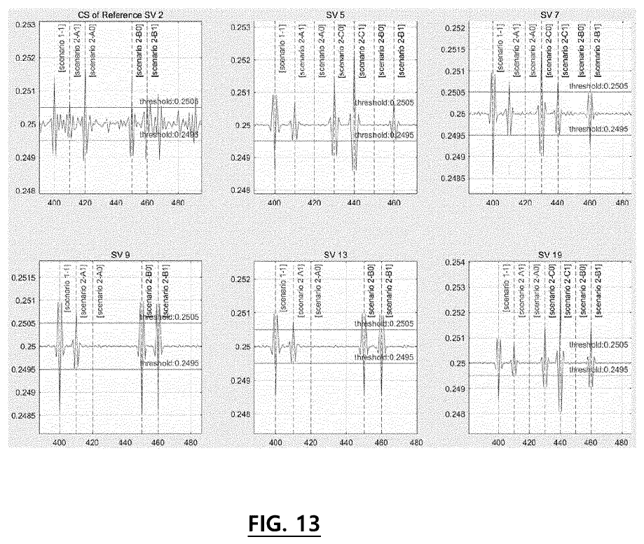

FIG. 13 is a graph in which the cross ratios of FIG. 12 are superimposed with the single-differenced cross ratios. The blue line in FIG. 13 represents the double-differenced cross ratio, and the red line represents the cross ratio of the single-differenced measurement, respectively.

In FIG. 12, scenarios 2-A0 and 2-A1 are situations in which CS occurs simultaneously in all channels, and in the case of 2-A0, where CS is the same magnitude, CS is not detected in all channels. However, as can be seen in FIG. 13, CS is detected in all channels. Meanwhile, in the case of scenarios 2-B0 and 2-B1, where CS occurs in the reference satellite and some channels, the CS occurrence channel can be distinguished, as can be seen in FIG. 13.

In other words, scenarios 2-C0 and 2-C1, where CS occurs only in some channels, can also be confirmed using the single-differenced value.

The above description of the invention is exemplary, and those skilled in the art can understand that the invention can be modified in other forms without changing the technical concept or the essential feature of the invention. Therefore, it should be understood that the above-mentioned embodiments are exemplary in all respects, but are not definitive. In particular, the features of the present invention described with reference to the drawings are not limited to the structures depicted in the specific drawings, and may be implemented independently or in combination with other features.

The scope of the invention is defined by the appended claims, not by the above detailed description, and it should be construed that all changes or modifications derived from the meanings and scope of the claims and equivalent concepts thereof are included in the scope of the invention.

What is claimed is:

1. A device for detecting a difference in cross ratios between channels, comprising:
a plurality of sensors, being arranged on the same plane, and configured for detecting signals transmitted through channels corresponding to one source and outputting raw time series measurements;
a signal processing unit, being configured for processing the raw time series measurements from each of the plurality of sensors to generate processed time series measurements;
a data processing unit, being configured for calculating cross ratios using the processed time series measurements corresponding to the plurality of sensors and connecting data between the plurality of sensors; and
a change detection unit, being configured for detecting a channel in which a difference in the cross ratio occurs.

2. The device according to claim 1, wherein the signal processing unit is configured for sequentially performs one or a combination of source difference, sensor difference, and time difference on the raw time series measurements using a geometric relationship between the source and the plurality of sensors to generate the processed time series measurement,
wherein the processed time series measurements are one of a single-differenced time series measurement, a double-differenced time series measurement, and a triple-differenced time series measurement.

3. The device according to claim 2, wherein the data processing unit is configured for estimating the processed time series measurements using a moving average filter.

4. The device according to claim 1, wherein each of the plurality of sensors is configured for detecting a plurality of signals transmitted through a plurality of channels, each corresponding to a plurality of sources, and generating the raw time series measurements for each channel,
wherein the signal processing unit is configured for processing the raw time series measurements for each channel from each of the plurality of sensors to generate the processed time series measurements,
wherein the data processing unit is configured for generating cross ratios with the processed time series measurements for each channel.

5. The device according to claim 1, wherein the change detection unit is configured to applying a threshold set according to a magnitude of the difference in cross ratios to be detected.

6. The device according to claim 1, wherein the differences between the cross ratios are identical in spatial and temporal domains.

7. A non-transitory computer program stored in a computer-readable medium that causes a computer to perform a method for detecting a difference in cross ratios between channels, the computer program causing a computer to perform the following steps, the steps including:
causing a plurality of sensors to detect signals transmitted through channels corresponding to one source, respectively, and outputting raw time series measurements;
processing the raw time series measurements from each of the plurality of sensors to generate processed time series measurements;
calculating cross ratios using the processed time series measurements corresponding to the plurality of sensors and an estimate through estimation; and
detecting a channel or sensor in which a difference in the cross ratio occurs based on the calculated cross ratios.

8. The non-transitory computer program according to claim 7, wherein the processed time series measurements are generated by sequentially performing one or a combination of source difference, sensor difference, and time difference on the raw time series measurements using a geometric relationship between the source and the plurality of sensors to generate the processed time series measurement,
wherein the processed time series measurements are one of a single-differenced time series measurement, a double-differenced time series measurement, and a triple-differenced time series measurement.

9. The non-transitory computer program according to claim 7, wherein the processing the raw time series measurements from each of the plurality of sensors to generate processed time series measurements further comprises
processing the processed time series measurements into the estimate.

10. The non-transitory computer program according to claim 9, wherein the calculating cross ratios using the processed time series measurements corresponding to the plurality of sensors and an estimate through estimation comprises:
calculating a first cross ratio with the raw or processed time series measurements;
calculating a second cross ratio by an estimation using the raw or processed time series measurements;
calculating a third cross ratio by combining the raw or processed time series measurements and the estimation;
complementarily storing, for comparison, the first to third cross ratios; and
complementarily connecting a cross ratio calculated from homogeneous sensors among the plurality of sensors and a cross ratio calculated between heterogeneous sensors among the plurality of sensors.

11. The non-transitory computer program according to claim 7, wherein the detecting a channel or sensor in which a difference in the cross ratio occurs based on the calculated cross ratios comprises:
setting a threshold according to a magnitude of difference of cross ratio between homogeneous sensors to be detected among the plurality of sensors;
detecting the difference of cross ratio by applying the threshold to the cross ratio; and
detecting the difference of cross ratio by connecting the cross ratios derived between the homogeneous sensors.
